(19) United States
(12) Patent Application Publication
(10) Pub. No.: US 2011/0075282 A1
(43) Pub. Date: Mar. 31, 2011

(54) DEFORMABLE MIRROR DEVICE AND SIGNAL PROCESSING APPARATUS

(75) Inventors: Sunao Aoki, Kanagawa (JP); Masahiro Yamada, Kanagawa (JP)

(73) Assignee: SONY CORPORATION, Tokyo (JP)

(21) Appl. No.: 12/882,681

(22) Filed: Sep. 15, 2010

(30) Foreign Application Priority Data
Sep. 28, 2009 (JP) 2009-222074

(51) Int. Cl. G02B 7/188

(52) U.S. Cl. 359/846

(57) ABSTRACT

A deformable mirror device includes: a flexible member having a mirror surface on a front surface and a convex cross-sectional shape pattern on a rear surface, the cross-sectional shape pattern having a protrusion at a pressing reference point and having the largest cross-sectional thickness, the flexible member further having a convex frame on the rear surface but outside a deformable region where the cross-sectional shape pattern is formed; a housing having a guide hole in a front surface of the housing, and an internal hole communicating with the guide hole, the frame of the flexible member positioned such that the center of the opening coincides with the pressing reference point and fixed to the front surface; a driving force transmitter having a column having a spherical tip, the column inserted into the guide hole so that the spherical tip comes into contact with the protrusion at the pressing reference point; and a driving force generator provided in the internal hole, one end of which bonded to an end of the driving force transmitter oriented away from the tip, the driving force generator generating a driving force pressing the driving force transmitter against the flexible member.

### BACKGROUND OF THE INVENTION

1. Field of the Invention

The present invention relates to a deformable mirror device in which a mirror surface is deformed, for example, to adjust the focus position of the light reflected off the mirror surface and correct a variety of aberrations of the reflected light, and a signal processing apparatus that receives the light traveling via the mirror surface of the deformable mirror device and performs signal processing on the received light signal.

2. Description of the Related Art

For example, in a drive apparatus that performs recording or reproducing operation on an optical-disc recording medium (also simply referred to as an optical disc), laser light is brought into focus through an objective lens in a recording layer of the optical disc so that a signal is recorded or reproduced.

When laser light is thus applied through an objective lens, it has been known that difference in thickness of a cover layer (cover thickness) that extends from the surface of the optical disc to the recording layer results in spherical aberration. For example, when the optical system is designed in such a way that the spherical aberration is minimized for a cover thickness intended for an optical disc in question, deviation in cover thickness from the intended value results in spherical aberration.

Variation in cover thickness of an optical disc therefore results in spherical aberration.

In recent years, a recording layer is multilayered to increase the recording capacity of an optical disc. When a recording layer is multilayered, the cover thicknesses for the recording layers, of course, differ from one another, resulting in spherical aberration produced when recording or reproducing operation is performed on a recording layer other than a reference recording layer.

When spherical aberration is introduced, focusing performance and hence signal recording and reproducing performance deteriorate. It is therefore necessary to provide some correction mechanism.

As a technique of related art for correcting such spherical aberration introduced due to the difference in cover thickness of an optical disc, a variety of ideas have been proposed in which the surface profile of a mirror in the optical system is deformed to make the correction (see, for example, JP-A-5-151591, JP-A-9-152505, JP-A-2006-155850, and JP-A-2009-130707).

Among them, the present inventor has proposed the inventions described in JP-A-2006-155850 and JP-A-2009-130707. Specifically, JP-A-2006-155850 and JP-A-2009-130707 relate to a deformable mirror device including a flexible member and a driver. The flexible member has a mirror surface formed thereon and a stepwise cross-sectional shape pattern or any other pattern so that a predetermined strength distribution is provided, and the driver applies a driving force to the flexible member to deform the shape of the mirror surface.

According to the configuration of the flexible member described in JP-A-2006-155850 and JP-A-2009-130707, the mirror surface can be deformed into a desired shape in response to a predetermined uniform driving force applied to the flexible member. Specifically, the mirror surface can be deformed into a desired shape without employing a complicated configuration, for example, described in JP-A-5-151591 in which a plurality of piezoelectric actuators are provided to apply driving forces partially different from one another. That is, the approach employed in JP-A-2006-155850 and JP-A-2009-130707 prevents the size of the deformable mirror device from increasing and allows the manufacturing cost of the device decreasing.

Further, according to the inventions described in JP-A-2006-155850 and JP-A-2009-130707, the flexible member can be deformed to a desired shape stepwise in accordance with the level of the applied driving force. It is therefore possible to provide two or more different deformed shapes of the mirror surface. This approach solves the disadvantage in the invention described in JP-A-9-152505 in which spherical aberration introduced in a recording layer formed of three or more layers may not be corrected. This approach also allows, even when there are two or more recording layers in addition to a recording layer used as a reference in designing the optical system, spherical aberration correction to be effectively made on all the recording layers.

FIGS. 9A and 9B show the configuration of a deformable mirror device as an example of related art proposed in JP-A-2009-130707 by the present inventor.

In FIGS. 9A and 9B, FIG. 9A is a cross-sectional view of a deformable mirror device 100 (before deformation) as an example of related art, and FIG. 9B is a cross-sectional view of a deformable mirror plate provided in the deformable mirror device 100.

As shown in FIG. 9A, the deformable mirror device 100 includes a deformable mirror plate 103, a magnet 104 fixed to a central portion of the rear surface of the deformable mirror plate 103, a housing 106 formed of a frame 106A and a base 106B, and a driving coil 105 provided in the housing 106 and surrounding the magnet 104.

As shown in FIG. 9B, the deformable mirror plate 103 has a reflection film (mirror surface) 102 formed on the front surface of a flexible member 101. The flexible member 101 is made, for example, of silicon and has a fixing portion and a pattern 101a on the rear surface, which is oriented away from the surface on which the reflection film 102 is formed. The fixing portion is formed in the outermost periphery of the rear surface and fixed to the frame 106A of the housing 106, and the pattern 101a is formed inside the fixing portion and has a stepwise cross-sectional shape in which the cross-sectional thickness gradually decreases from the center toward the periphery.

In the flexible member 101, the range where the cross-sectional shape pattern 101a excluding the fixing portion formed in the outermost periphery is provided deforms as a deformable mirror (deformable range). That is, forming the cross-sectional shape pattern 101a allows the shape of the mirror surface 102 to be deformed into a predetermined shape according to a vertical driving force applied uniformly to a central portion of the flexible member 101, as will be described later.

Further, the fixing portion formed in the outermost periphery of the flexible member 101 and having a large cross-sectional thickness allows the outermost periphery of the flexible member 101 to be provided with relatively high strength that prevents the outermost periphery of the flexible member 101 from deforming against the applied driving force. The high strength thus imparted to the outermost periphery of the flexible member 101 allows the shape of the deformable range, which has the cross-sectional shape pattern described above, deformed in response to the driving force to readily agree with an ideal deformed shape. That is, the deformed shape approaches an ideal shape more precisely than in a case where the outermost periphery of the flexible member 101 is deformed in response to the applied driving force.

Further, the cross-sectional shape pattern 101a in this case is a stepwise pattern in which the cross-sectional thickness gradually decreases from the center. The thus shaped pattern can prevent stress concentration in a limited portion when a driving force is applied to the flexible member 101 and hence effectively prevent cracking and fatigue breakdown of the flexible member 101.

When a certain driving force is applied to deform the mirror surface 102, internal stress is induced in the flexible member 101. In this process, if the stress is concentrated at a single point in the flexible member 101 and the flexible member 101 is made of a homogeneous isotropic material, the dimension of the portion in which the stress is concentrated sharply changes.

For example, when the stepwise pattern shown in FIGS. 9A and 9B is not used, the interval between portions having different cross-sectional thicknesses is small or large in a specific direction. The portion where the interval is small is where stress concentration occurs more easily than in the other portions and is hence where the dimension sharply changes when a uniform driving force is applied.

If such a portion where stress concentration occurs is present, the stress in the portion is likely greater than acceptable stress of the flexible member 101, likely resulting in cracking. Further, repeated deformation of the flexible member could result in fatigue breakdown in the portion described above.

The stepwise patterning shown in FIGS. 9A and 9B makes the intervals in the pattern uniform, which prevents stress concentration from occurring in a limited portion, unlike the case described above. It is therefore possible to prevent the cracking and fatigue breakdown described above.

As shown in FIG. 9A, the magnet 104 having a cylindrical shape is fixed to a central protrusion formed on the rear surface of the deformable mirror plate 103 having the flexible member 101.

Further, the fixing portion formed in the outermost periphery of the deformable mirror plate 103 is fixed to the frame 106A of the housing 106, as described above.

In this case, the frame 106A is made, for example, of borosilicate glass or Pyrex® glass, which is generally known as heat-resistant glass or hard glass. The primary reason for this is that the fact that Pyrex® glass has the same coefficient of thermal expansion as that of the flexible member 101 (silicon) prevents any change due to difference in the amount of expansion/contraction of the frame 106A and the fixing portion due to the difference in coefficient of thermal expansion, for example, when there is any change in temperature when anodic bonding or any other suitable technique is used to securely bond the fixing portion to the frame 106A or any change in temperature in a use environment after the bonding.

The frame 106A needs to maintain its initial state against the driving force or any other external force so that the deformation is precisely controlled. To this end, the frame 106A has a thickness much greater than that of the flexible member to show necessary strength. Using a material having the same coefficient of thermal expansion but high rigidity conveniently achieves a thin member.

As shown in FIG. 9A, the frame 106A has a tapered hole passing through a central portion thereof and has a box-like outer shape. The upper and lower surfaces of the frame 106A, each of which has an opening formed by the tapered hole, have an outer diameter dimension that coincides with the outer circumferential dimension of the surface of the deformable mirror plate 103 on which the mirror surface 102 is formed. The fixing portion of the deformable mirror plate 103 described above is fixed to one of the two surfaces. In this process, the deformable mirror plate 103 is fixed to the frame 106A in such a way that the central axes thereof are coaxially aligned. In this way, the fixing portion is fixed to the portion around the hole described above, which passes through the frame 106A.

The base 106B has a surface having the same outer dimension as that of the surface of the deformable mirror plate 103 on which the mirror surface 102 is formed. A groove is formed along the outermost periphery of the surface having the same dimension described above. The groove is provided to position and fix the surface of the frame 106A that is oriented away from the surface to which the deformable mirror plate 103 is fixed. Specifically, the base 106B has a circular protrusion having a diameter substantially equal to the inner diameter of the tapered hole at the level of the surface of the frame 106A that is oriented away from the surface to which the deformable mirror plate 103 is fixed. When the frame 106A is positioned and fixed by the groove formed by forming the protrusion described above, the frame 106A and the base 106B are disposed in such a way that the centers thereof are coaxially aligned.

Further, a circular positioning protrusion that fits with the inner wall of the driving coil 105 is formed in a central portion of the base 106B. Specifically, the protrusion is formed in such a way that the center thereof is coaxially aligned with the center of the base 106B, and the outer diameter of the protrusion is set in such a way that the outer wall thereof fits with the inner wall of the driving coil 105. When the driving coil 105 fits with the protrusion described above and is fixed to the base 106B, the outer surface of the magnet 104 is evenly spaced apart from the inner surface of the driving coil 105 around the entire circumference, and the magnet 104 and the driving coil 105 are disposed in such a way that the centers thereof are coaxially aligned.

Although not shown, lines through which a drive signal from a drive circuit is supplied are connected to the driving coil 105.

In the deformable mirror device 100 having the configuration described above, the mirror surface 102 is deformed in response to the drive signal supplied from the drive circuit to the driving coil 105.

Specifically, when the drive signal energizes the driving coil 105, a magnetic field according to the energized level is created, and the magnet 104 disposed inside the driving coil 105 receives a repellent force according to the thus created magnetic field. In this case, the magnet 104 has been magnetized in the axial direction of its cylindrical shape, and the repellent force is therefore oriented in the vertical direction (longitudinal direction). That is, a uniform driving force in the longitudinal direction according to the level of the drive signal is thus applied to a central portion of the deformable mirror plate 103 to which the magnet 104 is fixed.

FIGS. 10A and 10B are cross-sectional views of the deformable mirror device 100 at the time when the mirror surface is deformed in response to the thus supplied drive signal. FIG. 10A shows the mirror surface 102 deformed convexly, and FIG. 10B shows the mirror surface 102 deformed concavely. The change to the convex or concave shape is made by changing the polarity of the drive signal supplied to the driving coil 105.

The following description is made for confirmation purposes: Consider a case where spherical aberration correction and focus control are performed by using the thus configured deformable mirror device 100. When a driving force applied to the deformable mirror plate 103 (that is, the level of the drive signal supplied to the driving coil 105: drive signal value) is changed, the resultant driven state of the deformable mirror plate 103 needs to provide an intended focus position. That is, the resultant driven state needs to provide an intended deformed shape.

In the deformable mirror device 100 having the configuration described above, the deformation of the mirror surface 102 in a certain driven state (that is, in accordance with the amount of longitudinal deformation of the central protrusion of the deformable mirror plate 103) can be set by appropriately forming the cross-sectional shape pattern. A cross-sectional shape pattern that allows a certain driven state to provide an intended focus position can be determined, for example, by using an FEM (Finite Element Method) simulation tool.

In the deformable mirror device 100 described above as an example of related art, an electromagnetic actuator including the driving coil 105 and the magnet 104 deforms the deformable mirror plate 103. This configuration including a driver formed of the electromagnetic actuator described above is advantageous in driving the deformable mirror plate 103 at high speed.

For example, JP-A-2006-155850 (FIGS. 2, 3, 6, 8, and 9, for example) discloses a method for changing the pressure of a gas in a housing as a driving method for deforming a mirror surface. As compared with the method disclosed in JP-A-2006-155850, the method used in the deformable mirror device 100 for directly driving the deformable mirror plate 103 by the electromagnetic actuator can significantly increase the speed at which the mirror surface 102 is driven. Specifically, it is possible to increase the response frequency of the driver itself formed of the magnet 104 and the driving coil 105 to several tens of kilohertz.

Further, the deformable mirror device 100 as an example of related art has a moving magnet configuration, as a configuration for the electromagnetic force-based driving described above, in which the magnet 104 is fixed to the deformable mirror plate 103 (that is, movable unit) and the driving coil 105 is fixed to the base 106B (stationary unit). This configuration allows the precision in focus adjustment to be improved.

If the coil is fixed to the movable unit (deformable mirror plate 103) (the configuration shown in FIG. 16 in JP-A-2006-155850, for example), it is necessary to connect wiring cables for feeding power to the coil to the movable unit. In this configuration, however, stress induced, for example, when the power feeding cables are bent could apply pressure to the deformable mirror plate 103, disadvantageously resulting in deformation of the mirror surface 102 and hence deterioration of flatness thereof.

In contrast, employing a moving magnet configuration can prevent any pressure produced by the power feeding cable from being applied to the movable unit and hence allows the flatness to be ensured in a more reliable manner. Thus ensuring the flatness of the mirror surface 102 in its initial state (before deformation) allows the precision in focus adjustment to be improved.

Further, employing the moving magnet configuration in which the driving coil 105 is fixed to the base 106B allows heat generated in the driving coil 105 to be dissipated through the base 106B. For example, forming the base 106B with a material having relatively high thermal conductivity allows increase in temperature in the deformable mirror device 100 to be effectively suppressed.

Moreover, in the deformable mirror device 100 as an example of related art, the frame 106A is inserted between the base 106B and the deformable mirror plate 103 and the frame 106A disposed on the side where the base 106B is present supports the deformable mirror plate 103. This configuration prevents, when the deformable mirror device 100 is attached, for example, to a body of an optical disc drive apparatus and stress is induced in the deformable mirror device 100 in the attachment process, a force caused by the stress from being transmitted to the deformable mirror plate 103. That is, as a result, deterioration in flatness of the mirror surface 102 caused by the attachment can be effectively suppressed.

### SUMMARY OF THE INVENTION

The deformable mirror device 100 having been described as an example of related art, however, has the following problems.

First, there is a problem of responsiveness at high speed. In the moving-magnet deformable mirror device 100 of related art, the fact that the magnet 104 is fixed to the deformable mirror plate 103 makes it very difficult to improve the response speed at which the mirror surface 102 is deformed.

Specifically, in the moving-magnet deformable mirror device 100, a settable drive frequency used to deform the mirror surface 102 in a stable manner is limited by the natural frequency (primary resonance frequency) of the movable unit formed of the deformable mirror plate 103 and the magnet 104. When the natural frequency of the movable unit is high, the mirror surface 102 can be driven at a higher frequency accordingly.

The natural frequency F (Hz) of the movable unit formed of the deformable mirror plate 103 and the magnet 104 is determined by the spring constant k of the deformable mirror plate 103 and the equivalent mass (the mass of the deformable mirror plate 103+the mass of the magnet 104) m of the movable unit and specifically expressed by the following Equation 1:

F=½π√(k/m) [Equation 1]

As seen from the Equation 1, the natural frequency F is roughly proportional to the spring constant k (rigidity) and inversely proportional to the mass.

To increase the natural frequency F of the movable unit so that the mirror surface 102 is driven at high speed, the Equation 1 indicates that the spring constant k of the deformable mirror plate 103 may be increased or the equivalent mass m may be decreased.

It is, however, very difficult to arbitrarily set the spring constant (rigidity) of the deformable mirror plate 103 (flexible member 101) when a priority is placed on obtaining a predetermined deformed shape of the mirror surface 102. That is, the spring constant k of the deformable mirror plate 103 is determined by the material, the shape, and the size of the deformable mirror plate 103, and it is very difficult to arbitrarily set these parameters when a priority is placed on obtaining a predetermined deformed shape of the mirror surface 102.

It is also very difficult to set the equivalent mass m at an arbitrary value. Specifically, the equivalent mass m is dominantly affected by the mass of the magnet 104, but the mass of the magnet 104 dictates the magnitude of the driving force applied to the deformable mirror plate 103. It is therefore very difficult to arbitrarily set the mass of the magnet 104 and hence the equivalent mass m in consideration of the fact that a certain magnitude of driving force is necessary to change the mirror surface 102 to a predetermined deformed shape.

In consideration of the points described above, it has been believed to be difficult in the deformable mirror device 100 of related art to increase the natural frequency F of the movable unit, which is hence problematic in terms of responsiveness at high speed. That is, in the deformable mirror device 100 as an example of related art, although the electromagnetic actuator itself can be set to respond at high speed, the problem of the natural frequency F of the movable unit described above imposes an upper limit on a settable drive frequency, resulting in difficulty in high-speed driving.

Secondly, there is a problem of precision at which the mirror surface is deformed.

As seen from FIGS. 9A and 9B described above and FIGS. 10A and 10B, in the moving-magnet deformable mirror device 100, the magnet 104 fixed to the deformable mirror plate 103 is not in contact with the driving coil 105 or any components in the housing 106 at all and in what is called a free state. As a result, in the deformable mirror device 100 of related art, the direction in which the magnet 104 is driven is primarily controlled by the direction in which the magnet 104 is magnetized and the magnetic field created by the driving coil 105.

To obtain a predetermined deformed shape of the mirror surface 102, it is necessary to drive the magnet 104 accurately in the longitudinal direction so that a longitudinal driving force is applied accurately to the central portion of the deformable mirror plate 103.

It is, however, very difficult to accurately control the direction in which the magnet 104 is driven by setting the magnetization direction and the magnetic field created by the driving coil 105 described above. That is, in this regard, in the deformable mirror device 100 of related art, it has been believed to be difficult to apply a longitudinal driving force accurately to the central portion of the deformable mirror plate 103 (for example, the direction in which a driving force is applied is disadvantageously inclined to the longitudinal direction), and it is therefore difficult to change the mirror surface 102 accurately to a predetermined deformed shape.

It is therefore desirable to provide a deformable mirror device in view of the problems described above.

A deformable mirror device according to an embodiment of the invention includes a flexible member having a mirror surface formed on a front surface and a convex cross-sectional shape pattern formed on a rear surface oriented away from the front surface. The cross-sectional shape pattern has a protrusion located at a predetermined pressing reference point and has the largest cross-sectional thickness. The flexible member further has a convex frame formed on the rear surface but outside a deformable region in which the cross-sectional shape pattern is formed.

The deformable mirror device further includes a housing having a guide hole formed therein and accompanied by an opening formed in a front surface of the housing. The housing further has an internal hole that communicates with the guide hole. The frame of the flexible member is positioned in such a way that the center of the opening coincides with the pressing reference point and fixed to the front surface of the housing.

The deformable mirror device further includes a driving force transmitter having a column having a spherical tip. The column is inserted into the guide hole so that the spherical tip comes into contact with the protrusion formed at the pressing reference point of the flexible member.

The deformable mirror device further includes a driving force generator provided in the internal hole in the housing. One end of the driving force generator is bonded to an end of the driving force transmitter that is oriented away from the tip. The driving force generator generates a driving force that presses the driving force transmitter against the flexible member.

As described above, in the embodiment of the invention, the flexible member, on which the mirror surface is formed, is deformed by transmitting a driving force generated by the driving force generator via the driving force transmitter and applying the driving force to the flexible member. In this process, the tip of the driving force transmitter is not fixed to the flexible member but only comes into contact therewith.

According to the configuration described above, the natural frequency to be taken into consideration in setting the drive frequency can be divided into the natural frequency of the flexible member and the natural frequency of the driving force transmitter.

In this case, the mass of the flexible member is lighter than the equivalent mass (m) of the movable unit in the example of related art by the mass of the magnet. The natural frequency of the flexible member can therefore be significantly larger than that in the example of related art.

Further, the driving force transmitter does not necessarily have at least a certain size in order to provide a necessary driving force, unlike the magnet in the example of related art, but the mass of the driving force transmitter can therefore be sufficiently small. That is, as a result, the natural frequency of the driving force transmitter can also be sufficiently larger than the natural frequency of the movable unit in the example of related art.

As a result, according to the embodiment of the invention, the drive frequency can be set at a higher value than that in the example of related art, whereby the movable unit can be driven at higher speed.

Further, in the embodiment of the invention, the driving force transmitter includes the column having a spherical tip and inserted into the guide hole in the housing. This configuration allows the tip to apply a pressing force in the longitudinal direction (in the vertical direction to the front surface of the housing) accurately to the pressing reference point of the flexible member even if the direction in which the driving force generator generates the driving force is inclined to the longitudinal direction because the column is guided through the guide hole.

Further, in the embodiment of the invention, the tip of the driving force transmitter (column) has a spherical shape, which effectively prevents biased pressing, which could occur, for example, when the tip has a rectangular shape. The pressing force in the longitudinal direction can be applied accurately to the pressing reference point also in this regard.

As described above, according to the embodiment of the invention, the natural frequency of the movable unit, which moves when the mirror surface is deformed, can be higher than the natural frequency of the movable unit in the example of related art. As a result, the drive frequency can be set at a higher value than that in the example of related art, whereby the movable unit can be driven at higher speed.

According to the embodiment of the invention, the configuration in which the driving force transmitter (column) is guided through the guide hole allows the tip of the driving force transmitter to apply a longitudinal pressing force to accurately the pressing reference point of the flexible member.

Further, the spherical shape of the tip of the driving force transmitter (column) also allows the longitudinal pressing force to be applied accurately to the pressing reference point.

Since the longitudinal pressing force can thus be applied accurately to the pressing reference point, the mirror surface is deformed more precisely.

### BRIEF DESCRIPTION OF THE DRAWINGS

FIG. 1 shows a cross-sectional structure of a deformable mirror device as an embodiment;

FIG. 2 is an exploded perspective view of the deformable mirror device as an embodiment;

FIGS. 3A and 3B describe the structure of a deformable mirror plate provided in the deformable mirror device of the embodiment;

FIG. 4 describes an alignment method using an image recognition technique;

FIG. 5 shows a cross-sectional structure of the deformable mirror device in a deformed state;

FIG. 6 diagrammatically shows a vibration characteristic of a certain material;

FIG. 7 shows an internal configuration of an optical disc drive apparatus in which the deformable mirror device of the embodiment is incorporated;

FIG. 8 shows an internal configuration of an imaging apparatus in which the deformable mirror device of the embodiment is incorporated;

FIGS. 9A and 9B describe the configuration of a moving-magnet deformable mirror device as an example of related art; and

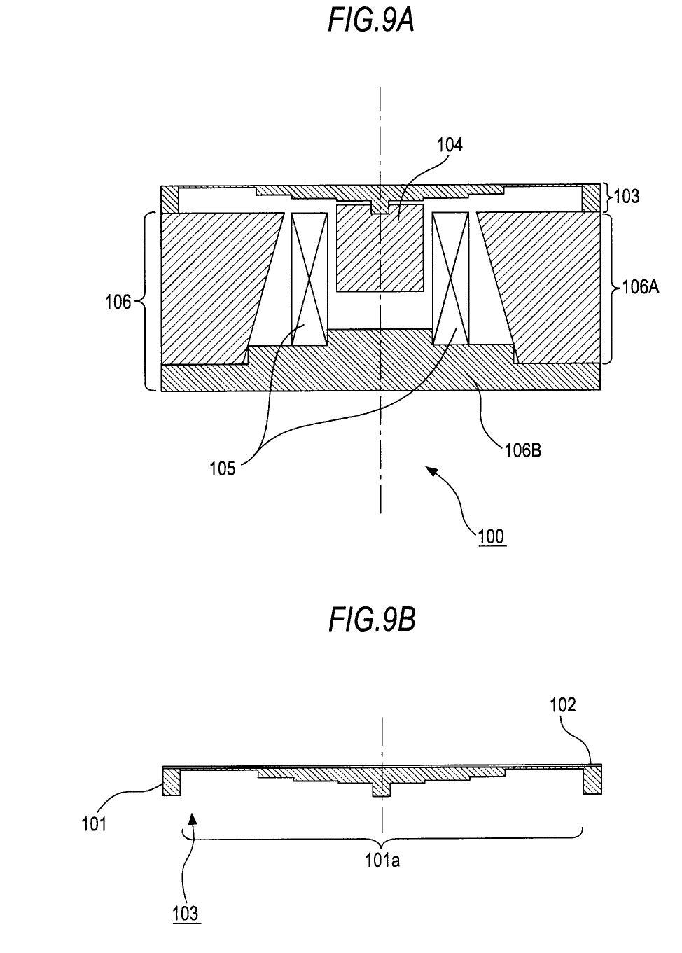

FIGS. 10A and 10B show a cross-sectional structure of the deformable mirror device of an example of related art in a deformed state.

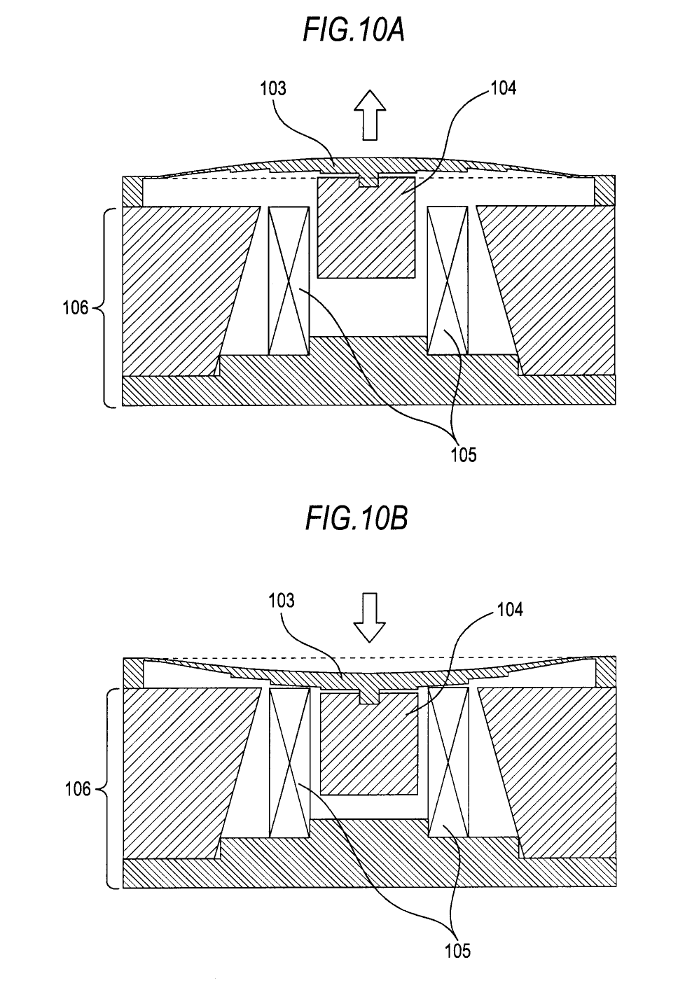

### DESCRIPTION OF THE PREFERRED EMBODIMENTS

The best mode for implementing the invention (hereinafter referred to as an embodiment) will be described below.

The description will be made in the following order.

<1. Deformable mirror device as embodiment>
[1-1. Configuration of deformable mirror plate]
[1-2. Overall configuration of deformable mirror device]
[1-3. How mirror surface is deformed]
[1-4. Summary of deformable mirror device of embodiment]
<2. Application example in optical disc drive apparatus>
<3. Application example in imaging apparatus>

### <4. Variations>

### <1. Deformable Mirror Device as Embodiment>

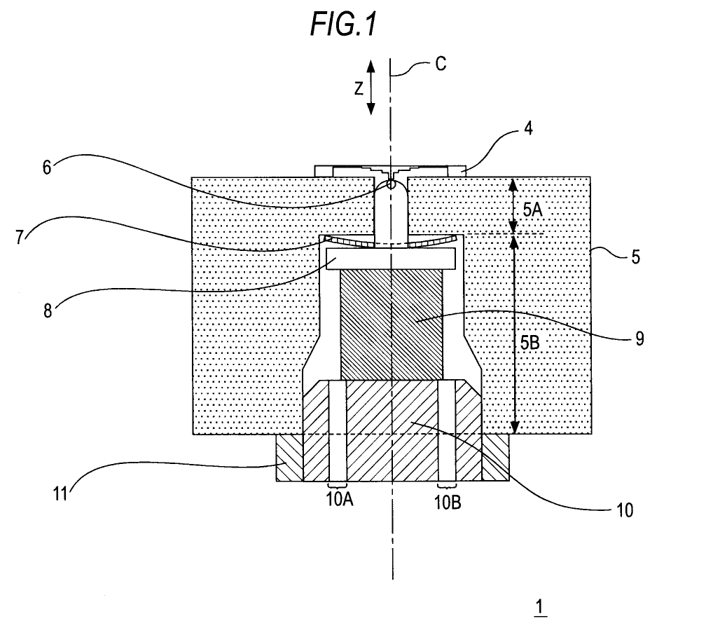

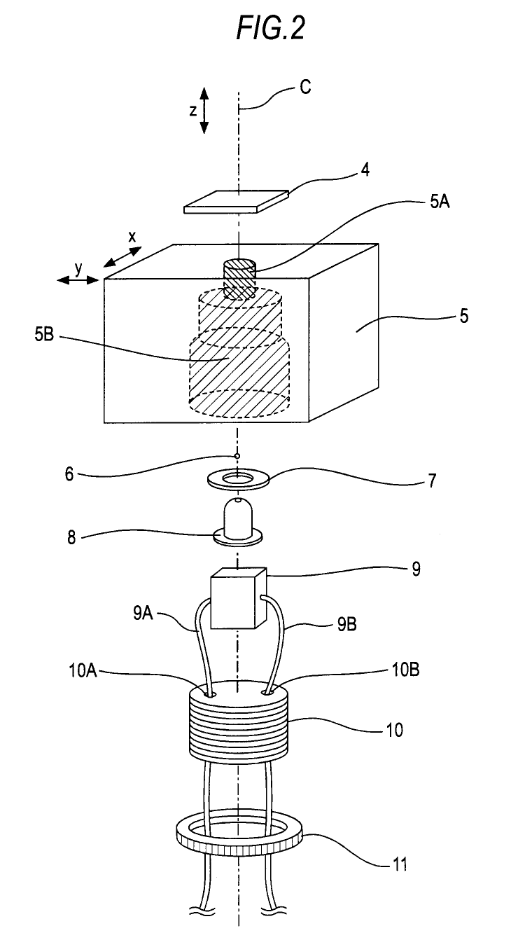

FIGS. 1 and 2 describe the structure of a deformable mirror device 1 according to an embodiment of the invention. FIG. 1 shows a cross-sectional structure of the deformable mirror device 1, and FIG. 2 is an exploded perspective view of the deformable mirror device 1.

As shown in FIGS. 1 and 2, the deformable mirror device 1 of the present embodiment includes a deformable mirror plate 4, a housing 5, a ball 6, a preloaded spring 7, a driving force transmitter 8, a driving force generator 9, an adjustment screw 10, and a lock nut 11.

### [1-1. Configuration of Deformable Mirror Plate]

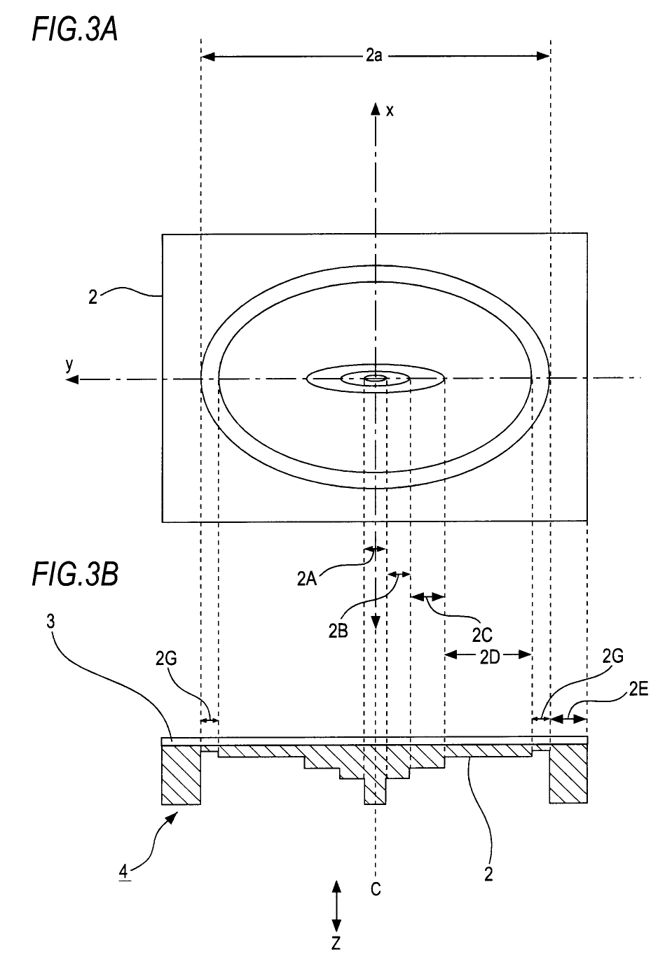

The structure of the deformable mirror plate 4 used in the present embodiment will first be described with reference to FIGS. 3A and 3B.

In FIGS. 3A and 3B, FIG. 3A is a plan view of the deformable mirror plate 4 viewed from the side (hereinafter referred to as a rear surface) oriented away from the side (hereinafter referred to as a front surface) on which a mirror surface, which will be described later, is formed, and FIG. 3B shows a cross-sectional structure of the deformable mirror plate 4.

As shown in FIG. 3B, the deformable mirror plate 4 has a reflection film 3 as the mirror surface deposited on the front surface of a flexible member 2.

In this case, the flexible member 2 is made of silicon and shows flexibility. The deformable mirror plate 4 is formed by depositing a metal film as the reflection film described above 3 that is made, for example, of aluminum on the surface (front surface) that will form the mirror surface of the flexible member 2.

In the following description, let an x-y plane be a plane parallel to the surface on which the reflection film (mirror surface) is formed and a Z-axis direction be the direction perpendicular to the x-y plane.

As shown in FIGS. 3A and 3B, the flexible member 2 has a plurality of elliptical portions (elliptical protrusions) 2A, 2B, 2C, and 2D having a common center C and formed on the rear surface of the flexible member 2. The plurality of elliptical portions 2A to 2D are formed in such a way that the elliptical portion 2A containing the center C has the largest thickness in the Z-axis direction, and that the elliptical portion 2B formed outside the elliptical portion 2A, the elliptical portion 2C formed outside the elliptical portion 2B, and the elliptical portion 2D formed outside the elliptical portion 2C have smaller thicknesses in the Z-axis direction in this order. That is, the flexible member 2 in this case is formed in such a way that the thickness thereof decreases stepwise from the center C toward the periphery thereof.

As clearly seen from FIGS. 3A and 3B, each of the elliptical protrusions formed on the rear surface of the flexible member 2 forms a convex shape. In other words, the side on which the mirror surface 3 is formed has a flat surface.

In the flexible member 2, the range from the elliptical portion 2A to the elliptical portion 2D and the range including a thin-walled portion 2G, which will be described later, form a range that deforms as a deformable mirror (deformable range). That is, a cross-sectional shape pattern formed in the deformable range described above allows the mirror surface 3 to have a predetermined deformed shape when a driving force in the Z-axis direction is applied to the central elliptical portion 2A. In this sense, the range including the elliptical portions 2A to 2D and the thin-walled portion 2G is called a cross-sectional shape pattern 2a for obtaining a predetermined deformed shape of the mirror surface 3.

Further, a rib-shaped frame 2E is formed in the outermost periphery of the flexible member 2. The frame 2E is provided to ensure strength large enough for the outermost periphery not to deform when a driving force in the Z-axis direction is applied to the flexible member 2 in a way described later.

Thus providing the outermost periphery of the flexible member 2 with strength large enough for the outermost periphery not to deform when a driving force is applied allows the deformed shape in the deformable range described above to readily agree with an ideal deformed shape. That is, the deformed shape of the mirror surface 3 can approach an ideal shape more precisely than in a case where the outermost periphery of the flexible member 2 is deformed.

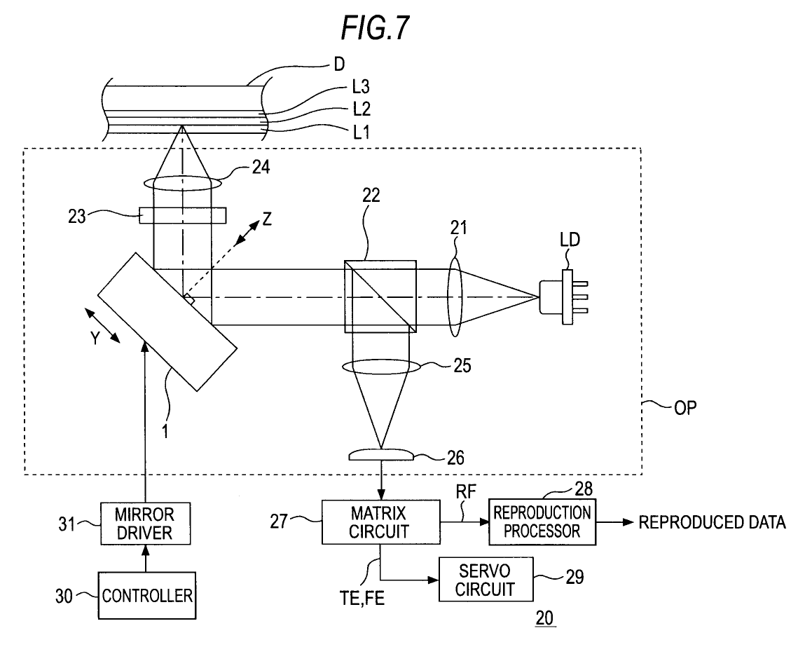

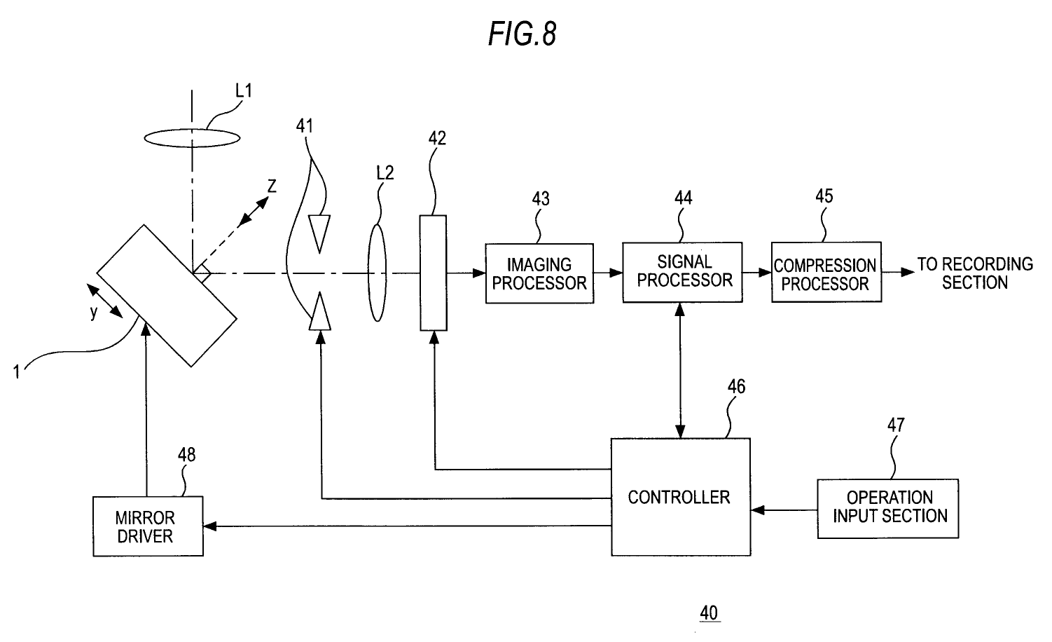

Further, according to the above description, the cross-sectional shape pattern 2a has an elliptical shape in the flexible member 2 of the present example. The reason for this is that the deformable mirror device 1 will be used as what is called a 45-degree inclined mirror, as will be described later with reference to FIGS. 7 and 8.

That is, as disclosed in JP-A-2006-155850 and JP-A-2009-130707 described above, a laser light irradiation spot formed on the mirror surface of the 45-degree inclined mirror has an elliptical shape. Specifically, the elliptical shape of the spot has its major direction that coincides with the y-axis direction shown in FIG. 3A and has its minor direction that coincides with the x-axis direction perpendicular to the y-axis direction. More specifically, the ratio of the diameter in the x-axis direction to the diameter in the y-axis direction is approximately x:y=1:√2.

Since the laser light spot on the mirror surface thus has an elliptical shape, the cross-sectional shape pattern 2a is also formed to have an elliptical shape.

Further, in the cross-sectional shape pattern 2a, the elliptical portions are disposed in such a way that they have the common center C, which can prevent stress concentration in a limited portion when a driving force is applied to the flexible member 2 and hence effectively prevent cracking and fatigue breakdown of the flexible member 2.

When a certain driving force is applied to deform the mirror surface, internal stress is induced in the flexible member 2. In this process, if the stress is concentrated at a single point in the flexible member 2 and the flexible member 2 is made of a homogeneous isotropic material as in the present example, the dimension of the portion in which the stress is concentrated sharply changes.

For example, when a pattern in which the elliptical portions do not have a common center is used, the interval is small or large in a specific direction. The portion where the interval is small is where stress concentration occurs more easily than in the other portions and is hence where the dimension sharply changes when a uniform driving force is applied.

If such a portion where stress concentration occurs is present, the stress in the portion is likely greater than acceptable stress of the flexible member 2, likely resulting in cracking. Further, repeated deformation of the flexible member 2 could result in fatigue breakdown in the portion described above.

Patterning the flexible member 2 in such a way that the elliptical portions have a common center as in the present example makes the intervals in the pattern uniform, which prevents stress concentration from occurring in a limited portion, unlike the case described above. That is, the cracking and fatigue breakdown described above will not occur.

Further, in the flexible member 2 in the present example, the thin-walled portion 2G provided by forming a cutout is formed in the outermost periphery of the deformable range having the cross-sectional shape pattern 2a described above. In the present example, the thin-walled portion 2G is provided by forming a cutout having a uniform width along the entire circumference of the elliptical portion 2D, which is adjacent to but inside the thin-walled portion 2G.

The thus formed thin-walled portion 2G has the smallest cross-sectional thickness in the flexible member 2 and is hence the most deformable portion. The thin-walled portion 2G thus shows the largest deformation curvature when a driving force is applied. As a result, the deformed shape of the mirror surface 3 (effective deformable range) readily coincides with a predetermined deformed shape even when the area of the elliptical portion 2D adjacent to the thin-walled portion 2G is reduced.

Moreover, the width of the thin-walled portion 2G is uniform along the entire circumference in the present example. This structure allows the driving force in the thin-walled portion 2G to be uniformly transmitted, which also readily allows the deformed shape of the mirror surface 3 to coincide with a predetermined deformed shape.

The point described above is also disclosed in JP-A-2006-155850.

### [1-2. Overall Configuration of Deformable Mirror Device]

The description will continue with reference to FIGS. 1 and 2 again.

The thus configured deformable mirror plate 4 is fixed to the front surface of the housing 5.

As shown in FIGS. 1 and 2, the housing 5 has a guide hole 5A formed therein. The guide hole 5A provides an opening in the front surface of the housing 5. The housing 5 further has an internal hole 5B that communicates with the guide hole 5A. The internal hole 5B passes through the housing 5 to the rear surface thereof, as shown in FIGS. 1 and 2.

In the present example, the deformable mirror plate 4 is fixed to the front surface of the housing 5 in such a way that the center C around which the elliptical portion 2A of the flexible member 2 is formed coincides with the center C of the guide hole. As clearly seen from FIG. 1, the frame 2E of the deformable mirror plate 4 (flexible member 2) is fixed to the front surface of the housing 5.

The cross-sectional shape pattern 2a shown in FIGS. 3A and 3B described above is set in such a way that the deformed shape of the mirror surface 3 coincides with a predetermined deformed shape when a driving force in the Z-axis direction is applied to the center C of the flexible member 2 (the center of the central elliptical portion 2A). That is, in the present example, a pressing reference point of the flexible member 2 (deformable mirror plate 4) is set at the center C.

As will be understood from the following description, in the deformable mirror device 1 of the present example, the point on the deformable mirror plate 4 to which a pressing force is applied is set at a point in the central axis of the guide hole 5A. To this end, it is important to have the center C of the deformable mirror plate 4 coincide with the center C of the guide hole 5A, as described above.

As an alignment method for having the centers C coincide with each other, a method using a typical image recognition technique can be used.

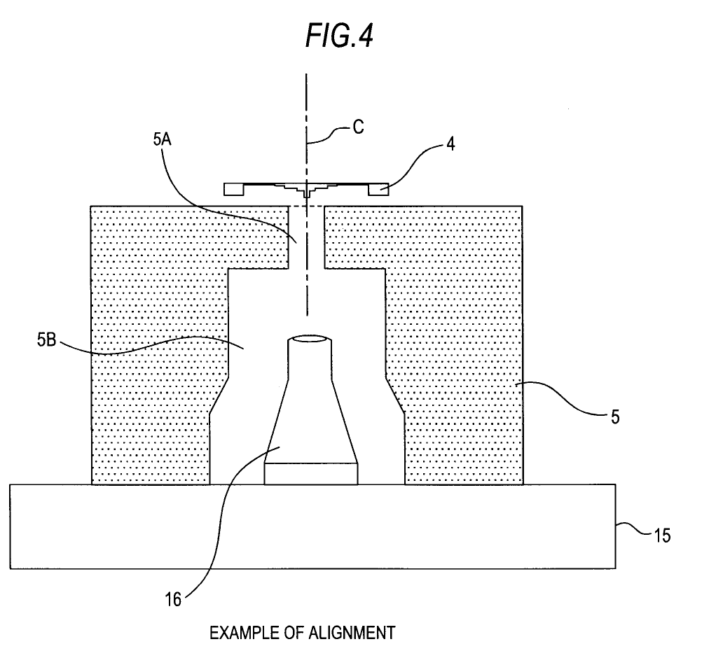

FIG. 4 describes an alignment method using an image recognition technique.

As shown in FIG. 4, the alignment in this case uses an XY stage 15 on which an imager 16 is provided. The housing 5 is placed on the XY stage 15 in such a way that the imager 16 is disposed in the internal hole 5B in the housing 5. In this process, the housing 5 is placed on the XY stage 15 in such a way that the guide hole 5A is within the field of view of the imager 16. The deformable mirror plate 4 is then disposed in a position facing the housing 5 placed on the XY stage 15 in such a way that the rear surface of the deformable mirror plate 4 faces the front surface of the housing 5.

After the housing 5 and the deformable mirror plate 4 are thus disposed, the imager 16 captures an image and image recognition is performed based thereon. The center C of the cross-sectional shape pattern 2a on the rear surface of the deformable mirror plate 4 is thus identified, and the XY stage 15 positions the housing 5 so that the center C of the cross-sectional shape pattern 2a coincides with the center C of the guide hole 5A. After the positioning is completed, the deformable mirror plate 4 is fixed to the front surface of the housing 5.

In this way, the center C of the deformable mirror plate 4 coincides with the center C of the guide hole 5A in a precise manner.

The alignment method is not limited to the method using the image recognition technique described above, but may alternatively be an easier method using a cylindrical positioning tool that fits into the guide hole 5A. That is, a tool having a recess (or a through hole) at the center of the upper surface of the tool, the recess having a shape that coincides with the central elliptical portion 2A of the flexible member 2, is used as the cylindrical tool described above. With the positioning tool fitting into the guide hole 5A, the deformable mirror plate 4 is fixed to the housing 5 by allowing the central elliptical portion 2A formed on the rear surface of the deformable mirror plate 4 to fit into the recess (through hole) of the tool. The method described above also allows the center C of the deformable mirror plate 4 to coincide with the center C of the guide hole 5A in a precise manner.

For example, any of the methods described above or any other suitable method is used to fix the deformable mirror plate 4 to the housing 5 with the center C of the deformable mirror plate 4 coinciding with the center C of the guide hole 5A.

Thereafter, a driver formed of the ball 6, the preloaded spring 7, the driving force transmitter 8, and the driving force generator 9 shown in FIGS. 1 and 2 is attached to the housing to which the deformable mirror plate 4 has thus been positioned and fixed.

The driving force transmitter 8 includes a cylindrical column having a diameter substantially equal to the diameter of the guide hole 5A and inserted into the guide hole 5A and amount connected to the root of the column. The driving force transmitter 8 thus has a substantially T-like cross-sectional shape.

The tip of the column is rounded, and a recess for receiving the ball 6 is formed in an apex portion of the column through which the central axis of the column passes.

The preloaded spring 7 is a donut-shaped disc spring having a hole which is formed in a central portion thereof and through which the column of the driving force transmitter 8 is inserted. The preloaded spring 7 functions as an urging member that urges the driving force transmitter 8 toward the rear surface of the housing 5.

The driving force generator 9 is a piezoelectric device and expands and contracts in the Z-axis direction in FIGS. 1 and 2 when a drive voltage is applied.

The driver formed of the ball 6, the preloaded spring 7, the driving force transmitter 8, and the driving force generator 9 is attached by using the adjustment screw 10.

A threaded hole (female thread) for engaging the adjustment screw 10 is formed on the sidewall of the internal hole 5B in the housing 5. To attach the driver described above, the adjustment screw 10 is inserted from the rear side of the housing and allowed to engage the internal hole 5B.

Specifically, before attaching the driver, the driving force transmitter 8 is first assembled. That is, the ball 6 is put in the recess at the tip of the column described above, and the preloaded spring 7, which is a donut-shaped disc spring, is attached to the column by inserting the column through the hole of the preloaded spring 7. The column is then inserted into the guide hole 5A. In this process, the attachment of the preloaded spring 7 formed of a disc spring is carried out in such a way that the preloaded spring 7 can urge the driving force transmitter 9 toward the rear surface of the housing 5 as described above. Specifically, the preloaded spring 7 is attached in such a way that it convexly protrudes toward the mount of the driving force transmitter 8, as shown in the cross-sectional view of FIG. 1.

With the column inserted into the guide hole 5A as described above and the driving force generator 9 disposed in the internal hole 5B, the adjustment screw 10 is then screwed. Before the adjustment screw 10 is thus screwed, the driving force generator 9 is disposed in the internal hole 5B in such a way that the direction in which the driving force generator 9 expands or contracts coincides with the Z-axis direction.

In the present embodiment, the adjustment screw 10 has insertion holes 10A and 10B for inserting wires for feeding power to the driving force generator 9. Although not shown in FIG. 1, two power feeding wires 9A and 9B are connected to the driving force generator 9 formed of a piezoelectric device, as shown in FIG. 2, and a drive voltage is applied through the power feeding wires 9A and 9B.

Before the adjustment screw 10 is screwed as described above, the power feeding wires 9A and 9B are inserted in advance through the insertion holes 10A and 10B in the adjustment screw 10 (see FIG. 2).

When the adjustment screw 10 is screwed to some extent, the upper surface of the adjustment screw 10 comes into contact with the lower surface of the driving force generator 9, and the upper surface of the driving force generator 9 comes into contact with the lower surface of the mount of the driving force transmitter 8. As the adjustment screw 10 is further screwed, the driving force transmitter 8 is pressed against the urging force produced by the preloaded spring 7 toward the front surface (upper surface) of the housing 5, and the ball 6 attached to the tip of the column of the driving force transmitter 8 comes into contact with the central elliptical portion 2A formed on the rear surface of the deformable mirror 4.

In an initial state in which no voltage is applied to the driving force generator 9, the shape of the mirror surface 3 is kept flat. If the ball 6 goes beyond the state in which the ball 6 is in contact with the elliptical portion 2A and presses the elliptical portion 2A, the mirror surface 3 is unintendedly deformed. The screwing operation of the adjustment screw 10 is therefore terminated when the state in which the ball 6 comes into contact with the elliptical portion 2A is reached.

In practice, whether or not the ball 6 comes into contact with the elliptical portion 2A is determined, for example, from the result of measurement of the flatness of the mirror surface 3.

The driver can thus be positioned in the Z-axis direction by thus screwing the adjustment screw 10.

The deformable mirror device 1 of the present embodiment further includes the lock nut 11 for fixing the driver in the position in the Z-axis direction adjusted by screwing the adjustment screw 10 as described above.

The lock nut 11 engages the adjustment screw 10, the position of which has been adjusted, and comes into contact with the rear surface of the housing 5 so that the adjustment screw 10 will not come loose. That is, the adjusted position of the driver in the Z-axis direction is thus fixed

### [1-3. How Mirror Surface is Deformed]

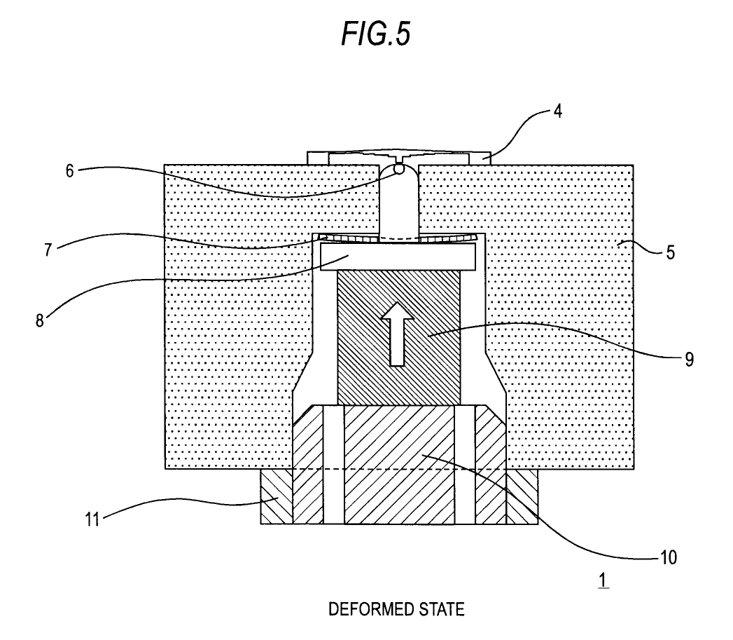

FIG. 5 shows a cross-sectional structure of the deformable mirror device 1 in a deformed state.

When a drive voltage is applied to the driving force generator 9, the driving force generator 9 expands in the Z-axis direction and lifts the driving force transmitter 8 against the urging force produced by the preloaded spring 7.

In this process, since the column of the driving force transmitter 8 is in intimate contact with the guide hole 5A without any play, the driving force transmitter 8 moves accurately in the direction in which the guide hole 5A is formed, that is, along the Z-axis direction. When the driving force transmitter 8 accurately moves in the Z-axis direction, the ball 6 attached to the tip of the driving force transmitter 8 accurately comes into point contact with the center (center C) of the central elliptical portion 2A formed on the rear surface of the deformable mirror plate 4 and presses the elliptical portion 2A.

When the pressing force is thus applied to the elliptical portion 2A, the deformable mirror plate 4 (mirror surface 3) is convexly deformed, as shown in FIG. 5.

When the application of the drive voltage to the driving force generator 9 is terminated, the driving force generator 9 contracts and returns to the initial state shown in FIG. 1.

The following description is made for confirmation purposes: When the driving force generator 9 contracts as described above, the urging force produced by the preloaded spring 7 causes the driving force transmitter 8 in contact with the driving force generator 9 to return back to the initial position. The deformable mirror plate 4, the central portion of the rear surface of which is in contact with the ball 6, also returns to its initial state.

### [1-4. Summary of Deformable Mirror Device of Embodiment]

As will be understood from the above description, the deformable mirror device 1 of the present embodiment deforms the deformable mirror plate 4, on which the mirror surface 3 is formed, by transmitting the driving force generated by the driving force generator 9 via the driving force transmitter 8 and applying the driving force to the deformable mirror plate 4 instead of directly applying the driving force to the deformable mirror plate 4. In this process, the tip of the driving force transmitter 8 (the ball 6 in the present example) is not fixed to the deformable mirror plate 4 but only comes into contact therewith.

According to the configuration described above, the natural frequency to be taken into consideration in setting the drive frequency can be divided into the natural frequency of the flexible member 2 and the natural frequency of the driving force transmitter 8.

In this case, the mass of the flexible member 2 is lighter than the equivalent mass m of the movable unit in the example of related art by the mass of the magnet 104. The natural frequency of the flexible member 2 can therefore be significantly larger than that in the example of related art.

Further, the driving force transmitter 8 does not necessarily have at least a certain size in order to provide a necessary driving force, unlike the magnet 104 in the example of related art, but the mass of the driving force transmitter 8 can therefore be sufficiently small. That is, as a result, the natural frequency of the driving force transmitter 8 can also be sufficiently larger than the natural frequency of the movable unit in the example of related art.

As a result, according to the present embodiment, the drive frequency can be set at a higher value than that in the example of related art.

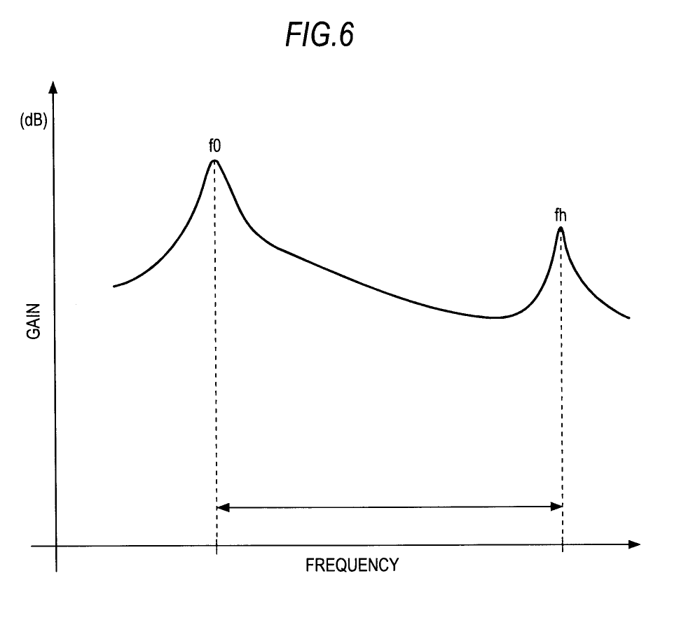

The following description is made for confirmation purposes: The relationship between the natural frequency of the movable unit in the deformable mirror device and the settable drive frequency of the deformable mirror device will be described with reference to FIG. 6.

FIG. 6 diagrammatically shows a vibration characteristic of a certain material.

The character f0 in FIG. 6 represents a primary resonance frequency (natural frequency).

In general, a material has a higher-order resonance point with respect to the natural frequency, and the higher-order resonance point is indicated by a higher-order resonance frequency fh in FIG. 6.

Consider now how to select the drive frequency. In the vicinity of the resonance frequency f0 and the resonance frequency fh in FIG. 6, it is shown that a slight change in frequency greatly changes the gain of vibration, which makes it difficult to perform stable control.

To address the problem, the band between f0 and fh is typically used as a drive frequency band.

In this case, when the primary resonance frequency f0 is higher, the higher-order resonance frequency fh is also shifted to a value in a higher frequency region. That is, as described above, increasing the natural frequency corresponding to the resonance frequency f0 allows the drivable band to be shifted toward a higher frequency region accordingly, and the thus increased natural frequency allows the drive frequency to be set at a value in a higher frequency region.

It is noted that the band up to f0 can be used as the drive frequency band when f0 is sufficiently high. In this case, the drive frequency can be set at a much higher value because f0 is higher.

Based on the assumption described above, consider a settable drive frequency of the deformable mirror device 1 of the present embodiment shown in FIG. 1.

According to the configuration of the deformable mirror device 1 shown in FIG. 1, since the deformable mirror plate 4 and the driving force transmitting section (driving force transmitter 8 and ball 6) are not fixed to each other, the natural frequency of the flexible member 2 (deformable mirror plate 4) and the natural frequency of the driving force transmitter 8 can be handled independently in setting the drive frequency.

As described above, the natural frequency of the deformable mirror plate 4 can be significantly higher than the natural frequency of the movable unit in the example of related art.

On the other hand, according to the configuration shown in FIG. 1, in which the preloaded spring 7 is provided, the natural frequency of the driving force transmitter 8 is determined in a strict sense by the mass of the driving force transmitter 8 (including the mass of the ball 6) and the spring constant of the preloaded spring 7.

As described above, the mass of the driving force transmitter 8 can be significantly smaller than the mass of the movable unit in the example of related art.

Further, the preloaded spring 7 can be any spring that can provide an urging form toward the rear surface of the housing 5, and the rigidity of the spring can be relatively freely set. The spring constant of the preloaded spring 7 can therefore be relatively large. As a result, the natural frequency of the driving force transmitter 8 can also be significantly larger than the natural frequency of the movable unit in the example of related art. In practice, the natural frequency of the driving force transmitter 8 can be set at a value equivalent to the natural frequency of the deformable mirror plate 4 or higher.

In consideration of these points, in the present embodiment, both the natural frequency of the deformable mirror plate 4 and the natural frequency of the driving force transmitter 8 can be larger than the natural frequency of the movable unit in the example of related art.

As a result, according to the present embodiment, it is possible to set a drive frequency higher than that in related art and hence deform the mirror surface 3 in a higher cycle.

Further, in the present embodiment, the driving force transmitter 8 includes the column having the ball 6 (sphere) placed at the tip thereof and inserted into the guide hole 5A in the housing 5. This configuration allows the ball 6 to apply a pressing force in the Z-axis direction accurately to the pressing reference point (the center C in this case) of the deformable mirror plate 4 even if the direction in which the driving force generator 9 generates the driving force is inclined from the Z-axis direction because the column is guided through the guide hole 5A.

Further, in the present embodiment, the tip of the driving force transmitter 8 (column) has a spherical shape by attaching the ball 6, which effectively prevents biased pressing, which could occur, for example, when the tip has a rectangular shape. The pressing force in the Z-axis direction can be applied accurately to the pressing reference point also in this regard.

As a result, since the pressing force in the Z-axis direction can be applied accurately to the pressing reference point, the mirror surface 3 is deformed more precisely.

The following description is made for confirmation purposes: In the present embodiment, the reason why the ball 6 is used to provide the spherical tip instead of shaping the tip of the column into a spherical tip is that a product having high sphericity and excellent surface roughness used, for example, in a ball bearing is readily available as the ball 6. In other words, according to the present embodiment using the ball 6, the efficiency with which the deformable mirror device 1 is manufactured is improved as compared with a case where the tip of the column is shaped into a spherical tip.

Further, in the present embodiment, the driving force generator 9 includes a piezoelectric device. In this configuration, the power consumption can be lower, for example, than in a case where an electromagnetic actuator is used as in the deformable mirror device 100 of the example of related art.

That is, although a piezoelectric device typically requires voltage application to hold its expanded state, the necessary amount of supplied current is relatively small. As a result, the power consumption can be reduced particularly in an application in which the deformation of the mirror surface 3 is maintained, and a piezoelectric device is therefore suitably used in a battery-driven mobile apparatus.

Further, a piezoelectric device can produce a relatively large driving force with respect to the size thereof. According to the present embodiment, in which a piezoelectric device is used as the driving force generator 9, the small size of the driving force generator 9 therefore allows the size of the housing 5 and hence the overall size of the deformable mirror device 1 to be reduced.

### <2. Application Example in Optical Disc Drive Apparatus>

A description will next be made of an application example of the deformable mirror device 1 as the embodiment described above.

FIG. 7 shows an exemplary configuration of an optical disc drive apparatus in which the deformable mirror device 1 as an embodiment is incorporated.

The optical disc drive apparatus in which the deformable mirror device 1 is incorporated is called an optical disc drive apparatus 20.

The following description is made for confirmation purposes: An optical disc refers to a disc-shaped optical recording medium. An optical recording medium is a generic name of recording media in which recorded information is reproduced by light application.

In FIG. 7, an optical disc D is a multilayer disc having a plurality of recording layers. It is assumed in the present example that the optical disc D is a BD (Blu-ray Disc®) or any other high recording density disc, and recording and reproducing operation is carried out, for example, by using an objective lens 24 having a numerical aperture NA of 0.85, which will be described later, and laser light having a wavelength of 405 nm.

In this case, the number of recording layers of the optical disc D is “3”. Specifically, a first recording layer L1, a second recording layer L2, and a third recording layer L3 are formed in this order from the side closest to the surface (front surface) onto which the laser light is applied.

The distance from the front surface to the first recording layer L1 is, for example, 0.075 mm. That is, the cover thickness for the first recording layer L1 is 0.075 mm. In this case, the distance between the recording layers is, for example, 25 μm, and therefore the cover thickness for the second recording layer L2 is 0.100 mm and the cover thickness for the third recording layer L3 is 0.125 mm.

In the following description, it is assumed as an example that the first recording layer L1 of the optical disc D is set as a reference recording layer that typically requires no spherical aberration correction. That is, the optical system in this case is designed and adjusted in such a way that the amount of spherical aberration is zero (no spherical aberration correction is necessary) when the mirror surface 3 in the deformable mirror device 1 is not deformed (is flat) and the first recording layer L1 of the optical disc D is brought into focus.

The optical disc drive apparatus 20 includes an optical pickup OP as the configuration for applying laser light onto the optical disc D.

Although not shown, a spindle motor is provided in the optical disc drive apparatus 20, and the optical disc D rotated by the spindle motor undergoes recording or reproducing operation.

In practice, as the configuration for recording information on the optical disc D, the configuration for driving a laser diode LD in FIG. 7 to cause it to emit light in accordance with recorded data is provided but not shown.

As shown in FIG. 7, the optical pickup OP includes the laser diode LD, a collimation lens 21, a polarizing beam splitter 22, the deformable mirror device 1, a ¼ wave plate 23, the objective lens 24, a collector lens 25, and a photodetector 26.

In the optical pickup OP, the laser light emitted from the laser diode LD is parallelized through the collimation lens 21 and then incident on the polarizing beam splitter 22. The polarizing beam splitter 22 transmits the laser light incident thereon from the collimation lens 21.

The laser light having passed through the polarizing beam splitter 22 is guided to the mirror surface 3 of the deformable mirror device 1.

The deformable mirror device 1 is disposed with the angle of the mirror surface 3 inclined to the optical axis of the incident laser light by 45 degrees. At the same time, the deformable mirror device 1 is attached to the optical pickup OP in such a way that the optical axis of the incident laser light coincides with the center C of the mirror surface 3. As a result, the laser light incident on the deformable mirror device 1 is reflected off the mirror surface 3 and the optical axis of the laser light is deflected by 90 degrees.

It is noted that the y-axis direction and the Z-axis direction shown in FIGS. 1, 2, 3A, and 3B are also shown in FIG. 7.

As shown in FIG. 7, the light reflected off the mirror surface 3 of the deformable mirror device 1 passes through the ¼ wave plate 23, is collected by the objective lens 24, and then impinges on the laser disc D.

The objective lens 24 is held movably in the direction in which a two-axis mechanism (not shown) causes the objective lens 24 approach or move away from the optical disc D (focusing direction) and in the radial direction of the optical disc D (tracking direction). The two-axis mechanism allows the position where the laser light having passed through the objective lens 24 is focused (focus position) to be selectively located in any of the first recording layer L1, the second recording layer L2, and the third recording layer L3.

On the other hand, the light reflected off any of the recording layers L of the optical disc D sequentially passes through the objective lens 24 and the ¼ wave plate 23, is reflected off the mirror surface 3 of the deformable mirror device 1, and then impinges on the polarizing beam splitter 22. The polarizing beam splitter 22 reflects the light reflected off the optical disc D and incident on the polarizing beam splitter 22 and guides the light to the collector lens 25.

The light reflected off the optical disc D and thus guided to the collector lens 25 is collected on a detection surface of the photodetector 26.

The photodetector 26 converts the reflected light into an electric signal, which forms a received light signal. The received light signal from the photodetector 26 is supplied to a matrix circuit 27 provided external to the optical pickup OP.

The matrix circuit 27 includes a current/voltage conversion circuit and a matrix computation/amplification circuit for processing the current outputted from a plurality of light receiving devices that form the photodetector 26 and produces necessary signals by performing matrix computation.

Specifically, these circuits produce a high-frequency signal obtained by reproducing a signal recorded on the optical disc D (hereinafter referred to as a reproduced signal RF), a focus error signal FE for focus servo control, and a tracking error signal TE for tracking servo control.

The reproduced signal RF produced in the matrix circuit 27 is supplied to a reproduction processor 28.

The focus error signal FE and the tracking error signal TE are supplied to a servo circuit 29.

The reproduction processor 28 binarizes the reproduced signal RF, decodes recording/modulation codes, corrects errors, and performs other reproduced signal processing for reproducing data recorded on the optical disc D. Reproduced data are thus obtained.

The servo circuit 29 produces a focus servo signal and a tracking servo signal from the focus error signal FE and the tracking error signal TE by performing servo computation and controls the two-axis mechanism described above based on the focus servo signal and the tracking servo signal. Focus servo control and tracking servo control are thus performed on the objective lens 24.

The optical disc drive apparatus 20 further includes a controller 30 and a mirror driver 31 as a configuration for driving and controlling the deformable mirror device 1.

The mirror driver 31 applies a drive voltage to the driving force generator 9 in the deformable mirror device 1 based on an instruction from the controller 30. Specifically, the power feeding wires 9A and 9B shown in FIG. 2 are connected to the mirror driver 31, and the driving force generator 9 is driven by feeding power to the driving force generator 9 through the power feeding wires 9A and 9B.

The controller 30 is formed of a microcomputer including a CPU (Central Processing Unit), a ROM (Read Only Memory), and other memories (storage devices) and performs controlling and processing operation according to a program stored, for example, in the ROM to control the entire optical disc drive apparatus 20.

In the present embodiment, the controller 30 particularly performs control for spherical aberration correction, which will be described below.

As described above, the optical system in the present example is designed and adjusted in such a way that the first recording layer L1 of the optical disc D is the reference recording layer that typically requires no spherical aberration correction. The controller 30 therefore controls the mirror driver 31 in such a way that the mirror surface 3 in the deformable mirror device 1 is not deformed when recording or reproducing operation is performed on the first recording layer L1.

Specifically, the controller 30 instructs the mirror driver 31 to change the drive voltage level to be provided to the deformable mirror device 1 (driving force generator 9) to a zero level when recording or reproducing operation is performed on the first recording layer L1 so that the mirror surface 3 is not deformed.

The state of the mirror surface 3 in the deformable mirror device 1 in this case is that shown in FIG. 1.

On the other hand, the mirror driver 31 is controlled in such a way that the mirror surface 3 is deformed when recording or reproducing operation is performed on the second recording layer L2 or the third recording layer L3.

Specifically, when recording or reproducing operation is performed on the second recording layer L2, the controller 30 instructs the mirror driver 31 to change the drive voltage level to be provided to the driving force generator 9 to a first predetermined level that has been determined in advance. In this way, a drive voltage having the first predetermined level is applied to the driving force generator 9.

When the drive voltage having the first predetermined level is applied to the driving force generator 9, the central portion of the mirror surface 3 is displaced in the Z-axis direction by a predetermined amount of deformation Δ1, and the shape of the mirror surface 3 is deformed in accordance with the amount of deformation Δ1.

When recording or reproducing operation is performed on the third recording layer L3, the controller 30 instructs the mirror driver 31 to change the drive voltage level to be provided to the driving force generator 9 to a second predetermined level, which is higher than the first predetermined level. In this way, a drive voltage having the second predetermined level is applied to the driving force generator 9.

When the drive voltage having the second predetermined level is applied to the driving force generator 9, the central portion of the mirror surface 3 is displaced in the Z-axis direction by the amount of deformation Δ2, which is greater than the amount of deformation Δ1, and the shape of the mirror surface 3 is deformed in accordance with the amount of deformation Δ2.

As described above, the cross-sectional shape pattern 2a formed on the deformable mirror plate 4 dictates the shape of the mirror surface 3 deformed when a certain driving force is applied to the pressing reference point (that is, when the central portion of the deformable mirror plate 4 is deformed by the amount of deformation Δ).

The cross-sectional shape pattern 2a in this case is formed in such a way that the shape of the mirror surface 3 is changed in correspondence with the amount of deformation Δ1 for the recording layer L2 so that the spherical aberration introduced in accordance with the shift in cover thickness by 0.025 mm is corrected and the shape of the mirror surface 3 is changed in correspondence with the amount of deformation Δ2 for the recording layer L3 so that the spherical aberration introduced in accordance with the shift in cover thickness by 0.050 mm is corrected.

In this way, the spherical aberration correction in the second recording layer L2 and the third recording layer L3 is made properly.

The cross-sectional shape pattern 2a formed on the deformable mirror plate 4 (flexible member 2) is thus an important factor for providing a predetermined deformed shape of the mirror surface 3 for spherical aberration correction. The cross-sectional shape pattern 2a for providing a predetermined deformed shape in accordance with the magnitude of the driving force applied as described above (the amount of deformation Δ) can be determined, for example, by using an FEM (Finite Element Method) simulation tool.

Although not stated in the above description, the spherical aberration correction can also be made over a single track of a disc as well as the spherical aberration correction made in each of the recording layers L. That is, the spherical aberration correction is made by taking into consideration of variation in cover thickness in each of the recording layers L on which recording or reproducing operation is performed.

As understood from the above description, the deformable mirror device 1 of the present embodiment can respond at higher speed than in related art. The deformable mirror device 1 of the present embodiment can therefore be preferably used in the case where the spherical aberration correction is made over each single track of a disc.

The above description has been made with reference to the case where the deformable mirror device 1 is used in an optical disc drive apparatus to correct spherical aberration. The following usages are also conceivable, for example, when a bulk-recording optical disc, which is expected to become popular, is intended to be used.

The bulk-recording optical disc described above has what is called a bulk recording layer, and multilayer recording is performed in the bulk layer. What is characteristic with the bulk recording is that the bulk layer has no guide groove or reflection film for each recording layer unlike current multilayer discs.

In consideration of reproducing operation, however, recording positions must be organized to some extent. To this end, a bulk-recording optical disc has a reference plane, which works as a reference for focus servo and tracking servo, only in one layer. In the reference plane are recorded information on absolute position, such as information on the radial position on a disc and information on the rotating angle of the disc, by using a pit row or a wobbling groove, and a reflection film is deposited on the reference plane.

In general, the reference plane is provided on the front side away from the bulk layer (when viewed from the side where laser light is outputted).

Based on the medium structure described above, recording/reproducing light for performing recording/reproducing operation and servo light for performing tracking servo and focus servo with respect to the reference plane are used in a bulk-recording optical disc drive apparatus.

What is characteristic is that the recording/reproducing light and the servo light are applied through a common objective lens.

In the drive apparatus in this case, to achieve tracking servo and focus servo with respect to the reference plane by using the servo light, a photodetector for the servo light (servo photodetector) is provided separately from the photodetector for the recording/reproducing light described above.

As a specific configuration of an overall optical system including an optical system for the servo light, for example, assuming that a set of “the laser diode LD, the collimation lens 21, the polarizing beam splitter 22, the collector lens 25, and the photodetector 26” shown in FIG. 7 is a light emitting/light receiving system for the recording/reproducing light described above, a light emitting/light receiving system formed of another set of “the laser diode LD, the collimation lens 21, the polarizing beam splitter 22, the collector lens 25, and the photo-detector 26” for the servo light is added separately from the emitting/light receiving system shown in FIG. 7. The light emitting/light receiving system for the servo light is provided in such a way that the servo light having exited from the polarizing beam splitter 22 in the light emitting/light receiving system for the servo light is combined with the recording/reproducing light, for example, between the ¼ wave plate 23 and the deformable mirror device 1 shown in FIG. 7. That is, the servo light is applied along with the recording/reproducing light onto the optical disc through the objective lens 24, and the reflected servo light is independently guided to the photodetector 26 (servo photodetector) in the light emitting/light receiving system for the servo light.

The focus servo control and the tracking servo control are performed on the objective lens 24 based on the received light signal from the servo photodetector, as described above. Specifically, the position of the objective lens 24 is controlled by performing the focus servo with respect to the reference plane described above and performing the tracking servo so that the objective lens 24 follows the pit row or the groove formed in the reference plane.

In this process, the recording/reproducing light is applied along with the servo light through the objective lens 24. The position of the recording/reproducing light in the tracking direction can therefore follow the pit row or the groove in the reference plane. That is, the position of the recording/reproducing light in the tracking direction can be controlled by controlling the objective lens 24 based on the reflected servo light described above.

As understood from the above description, the recording/reproducing light needs to be focused in the bulk layer formed under the reference plane.

Since performing the servo control on the objective lens 24 only based on the reflected servo light described above disadvantageously causes the recording/reproducing light to be focused on the reference plane, the position where the recording/reproducing light is focused needs to be independently controlled by some mechanism.

As the configuration for independently controlling the position where the recording/reproducing light is focused, the deformable mirror device 1 of the present embodiment can be used.

That is, based on the configuration in which the servo light is combined (separated in the case of reflected light) between the ¼ wave plate 23 and the deformable mirror device 1 as illustrated above, the deformable mirror device 1 disposed in the position shown in FIG. 7 can independently control the position where the recording/reproducing light is focused.

To control the position where the recording/reproducing light is focused in this case, the amount of focus offset according to the distance from the reference plane to the position of each of the layers in the bulk layer may be set in advance, and the deformable mirror device 1 may adjust the focus position by providing the amount of focus offset for the recording/reproducing light in accordance with the position of the layer on which recording operation is performed.

The focus control of the recording/reproducing light in recording operation has been described above. On the other hand, when reproducing operation is performed on a bulk-recording optical disc, rows of recording marks having been formed in the bulk layer can be used to identify each recording position (layer position) in the depth direction, whereby the focus servo in reproducing operation can be performed based on reflected recording/reproducing light. Specifically, the deformable mirror device 1 is driven and controlled in such a way that the focus point of the recording/reproducing light is maintained coincident with the layer position (rows of recording marks) in question based on a focus error signal produced from the reflected recording/reproducing light.

When reproducing operation is performed on a bulk-recording optical disc as described above, it is contemplated to use the deformable mirror device 1 as a focus servo adjustment device. The deformable mirror device 1 of the present embodiment, which excels in responsiveness at high speed as described above, can also be preferably used as a focus servo adjustment device.

### <3. Application Example in Imaging Apparatus>

A description will next be made of an application example in which the deformable mirror device 1 as an embodiment is used in an imaging apparatus with reference to FIG. 8.

The imaging apparatus in which the deformable mirror device 1 is incorporated is called an imaging apparatus 40.

In FIG. 8, the imaging apparatus 40 is configured as a digital camera capable of capturing and recording a still image and video images.

First, a lens L1, the deformable mirror device 1, a lens L2, and a diaphragm 41 in FIG. 8 are provided as an imaging optical system.

Each of the lens L1 and the lens L2 described above diagrammatically shows a lens group in the imaging optical system for focusing subject light (image) on an imaging device 42, which will be described later. The lens L1 diagrammatically shows a lens group for guiding the subject light to the deformable mirror device 1 disposed as a 45-degree inclined mirror as shown in FIG. 8, and the lens L2 diagrammatically shows a lens group for guiding the subject light passing through the lens L1 and reflected off the mirror surface 3 of the deformable mirror device 1 to the imaging device 42.

In practice, the imaging optical system includes a larger number of lenses and other optical elements.

The deformable mirror device 1 is driven by a mirror driver 48 shown in FIG. 8. Specifically, the power feeding wires 9A and 9B shown in FIG. 2 are connected to the mirror driver 48, and feeding power to the driving force generator 9 through the power feeding wires 9A and 9B causes the mirror surface 3 of the deformable mirror device 1 to be deformed.

Further, in the imaging optical system, the diaphragm 41 is inserted between the deformable mirror device 1 and the lens L2 and adjusts the amount of light of an optical image to be focused on the imaging device 42 by changing the range through which the incident light passes under the control of a controller 46, which will be described later.

The imaging device 42 is formed, for example, of a CCD (Charge Coupled Device) sensor or a CMOS (Complementary Metal Oxide Semiconductor) sensor, converts the subject light focused through the imaging optical system described above into an electric signal, and provides a captured image signal formed of three color components, R (red), G (green), and B (blue).

The controller 46, which will be described later, controls image readout operation in the imaging device 42.

An imaging processor 43 includes a sample hold/AGC (Automatic Gain Control) circuit that performs gain adjustment and waveform shaping on the signal produced by (read out from) the imaging device 42 and a video A/D converter that produces digital captured image data. The imaging processor 43 further performs sensitivity variation correction and white balance processing on the captured image data.

A signal processor 44 performs a variety of image signal processes on the captured image data (R, G, and B) produced by the imaging processor 43. For example, the signal processor 44 performs grayscale correction, shading correction, and high-frequency range correction (contour correction).

The signal processor 44 further performs focus evaluation value calculation for calculating a focus evaluation value, which is an evaluation index for performing autofocus control. The focus evaluation value can be calculated, for example, based on the contrast value of the captured image data or the magnitude of a high-frequency component.

A compression processor 45 compresses the captured image data on which the image signal processing has been performed in the signal processor 44. For example, the compression processor 45 produces compressed still image data based on the JPEG (Joint Photographic Experts Group) scheme or compressed video image data based on the MPEG (Moving Picture Experts Group) scheme.

The compressed image data produced by the compression processor 45 are supplied to a recording section (not shown) and recorded on a recording medium.

An operation input section 47 includes keys, buttons, dials, and other operational components, including an operational component for instructing a power supply to be turned on and off, an operational component for instructing start and stop of recording a captured image, and other operational components for issuing a variety of action instructions and for inputting information.

The operation input section 47 supplies information inputted through operation to the controller 46, and the controller 46 performs necessary computation and control corresponding to the information inputted the through operation. In this way, the imaging apparatus 40 carries out an action corresponding to an input through operation.

The controller 46 is formed of a microcomputer including a CPU, a ROM, and other memories and performs controlling and processing operation according to a program stored, for example, in the ROM to control the entire imaging apparatus 40.

For example, the controller 46 drives and controls the diaphragm 41 based on information on the amount of light expressed in the form of an imaged signal detected by the imaging processor 43 to provide an adequate diaphragm value.

The controller 46 further controls timing at which an image is read out from the imaging device 42.

In the present example, the controller 46 particularly instructs the mirror driver 48 to control the deformation of the deformable mirror device 1 based on the focus evaluation value calculated in the signal processor 44. Autofocus control is thus performed.

The deformable mirror device 1 can thus also be preferably used as a focusing device in an imaging apparatus.

### <4. Variations>

The embodiment of the invention has been described above, but the invention should not be limited to the specific example described above.

For example, the above description has been made of the case where the cross-sectional shape pattern 2a is formed by assuming that the pressing reference point is set at the center C of the flexible member 2. The pressing reference point can alternatively be set at a point other than the center C.

As described, for example, with reference to FIGS. 21 and 22 in JP-A-2006-155850, when the deformable mirror device is used as a 45-degree inclined mirror, it is conceivable to form a cross-sectional shape pattern having an eccentric elliptical shape. In this case, the pressing reference point is set at a point other than the center C.

In any case, the cross-sectional shape pattern may be any pattern in which a protrusion including a pressing reference point has the largest cross-sectional thickness, and the configuration for applying a driving force to the flexible member on which the cross-sectional shape pattern is formed may be any configuration in which a protrusion including the pressing reference point comes into point contact with and is pressed by a column having a spherical tip.

The above description has been made with reference to the case where the cross-sectional shape pattern 2a has an elliptical shape, but the cross-sectional shape pattern in the invention should not be limited thereto. As described, for example, in JP-A-2006-155850, when the deformable mirror device is used as a 180-degree reflection mirror (changes the optical axis of the incident light by 180 degrees), a circular cross-sectional shape pattern can alternatively be formed.

Further, the shape and specific material of each of the components and portions of the deformable mirror device should not be limited to those described above, but can be changed as appropriate to the extent that they do not depart from the invention.

For example, the driving force generator 9 is not limited to a piezoelectric device but can alternatively be an electromagnetic actuator or any other similar device.

Further, the preloaded spring 7 is not limited to a disc spring but can alternatively be any other suitable urging member. Alternatively, the preloaded spring 7 itself can be omitted.

Moreover, the configuration for supporting the driver including the driving force transmitter 8 and the driving force generator 9 from the rear side of the housing 5 is not limited to the adjustment screw 10 but can alternatively be any other suitable configuration.

The above description has been made with reference to the case where the deformable mirror device according to the embodiment of the invention is used in an optical disc drive apparatus and an imaging apparatus. The deformable mirror device according to the embodiment of the invention can alternatively be used in an electron microscope and other similar apparatus in a preferable manner.

The present application contains subject matter related to that disclosed in Japanese Priority Patent Application JP 2009-222074 filed in the Japan Patent Office on Sep. 28, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A deformable mirror device comprising:
a flexible member having a mirror surface formed on a front surface and a convex cross-sectional shape pattern formed on a rear surface oriented away from the front surface, the cross-sectional shape pattern having a protrusion located at a predetermined pressing reference point and having the largest cross-sectional thickness, the flexible member further having a convex frame formed on the rear surface but outside a deformable region in which the cross-sectional shape pattern is formed;
a housing having a guide hole formed therein and accompanied by an opening formed in a front surface of the housing, the housing further having an internal hole that communicates with the guide hole, the frame of the flexible member positioned in such away that the center of the opening coincides with the pressing reference point and fixed to the front surface of the housing;
a driving force transmitter having a column having a spherical tip, the column inserted into the guide hole so that the spherical tip comes into contact with the protrusion formed at the pressing reference point of the flexible member; and
a driving force generator provided in the internal hole in the housing, one end of the driving force generator bonded to an end of the driving force transmitter that is oriented away from the tip, the driving force generator generating a driving force that presses the driving force transmitter against the flexible member.

2. The deformable mirror device according to claim 1,
wherein the driving force generator includes a piezoelectric device.

3. The deformable mirror device according to claim 1,
wherein a sphere is attached to the tip of the column of the driving force transmitter to form the spherical tip.

4. The deformable mirror device according to claim 1,
further comprising an urging member that urges the driving force transmitter toward a rear surface of the housing.

5. The deformable mirror device according to claim 4,
wherein the driving force transmitter has amount formed at a root portion of the column and hence has a substantially T-like cross-sectional shape, and
the urging member is a donut-shaped disc spring having a hole through which the column of the driving force transmitter is inserted.

6. The deformable mirror device according to claim 1,
wherein the internal hole passes through a rear surface of the housing,
the sidewall of the internal hole is threaded,
the deformable mirror device further comprises an adjustment screw that engages the threaded internal hole, and
the adjustment screw that engages the internal hole adjusts the position of the driving force generator.

7. The deformable mirror device according to claim 6,
further comprising a lock nut for fixing the position of the adjustment screw that engages the internal hole.

8. The deformable mirror device according to claim 1,
wherein the cross-sectional shape pattern on the flexible member is configured in such a way that the cross-sectional thickness thereof decreases stepwise from the pressing reference point toward the periphery.

9. The deformable mirror device according to claim 8,
wherein the cross-sectional shape pattern on the flexible member is formed of a plurality of elliptical portions having different cross-sectional thicknesses.

10. The deformable mirror device according to claim 1,
wherein the flexible member has a thin-walled portion, which is provided by forming a cutout, formed in an outermost periphery of the deformable region in which the cross-sectional shape pattern in provided.

11. A signal processing apparatus comprising:
a deformable mirror device including a flexible member having a mirror surface formed on a front surface and a convex cross-sectional shape pattern formed on a rear surface oriented away from the front surface, the cross-sectional shape pattern having a protrusion located at a predetermined pressing reference point and having the largest cross-sectional thickness, the flexible member further having a convex frame formed on the rear surface but outside a deformable region in which the cross-sectional shape pattern is formed,
a housing having a guide hole formed therein and accompanied by an opening formed in a front surface of the housing, the housing further having an internal hole that communicates with the guide hole, the frame of the flexible member positioned in such a way that the center of the opening coincides with the pressing reference point and fixed to the front surface of the housing,
a driving force transmitter having a column having a spherical tip, the column inserted into the guide hole so that the spherical tip comes into contact with the protrusion formed at the pressing reference point of the flexible member, and
a driving force generator provided in the internal hole in the housing, one end of the driving force generator bonded to an end of the driving force transmitter that is oriented away from the tip, the driving force generator generating a driving force that presses the driving force transmitter against the flexible member;
an optical system configured to guide light traveling via the mirror surface of the deformable mirror device to an light receiving device; and
a signal processor that receives a received light signal produced by the light receiving device and performs necessary signal processing on the received light signal.

12. An optical pick up apparatus comprising:
a deformable mirror device including a flexible member having a mirror surface formed on a front surface and a convex cross-sectional shape pattern formed on a rear surface oriented away from the front surface, the cross-sectional shape pattern having a protrusion located at a predetermined pressing reference point and having the largest cross-sectional thickness, the flexible member further having a convex frame formed on the rear surface but outside a deformable region in which the cross-sectional shape pattern is formed,
a housing having a guide hole formed therein and accompanied by an opening formed in a front surface of the housing, the housing further having an internal hole that communicates with the guide hole, the frame of the flexible member positioned in such away that the center of the opening coincides with the pressing reference point and fixed to the front surface of the housing,
a driving force transmitter having a column having a spherical tip, the column inserted into the guide hole so that the spherical tip comes into contact with the protrusion formed at the pressing reference point of the flexible member, and
a driving force generator provided in the internal hole in the housing, one end of the driving force generator bonded to an end of the driving force transmitter that is oriented away from the tip, the driving force generator generating a driving force that presses the driving force transmitter against the flexible member;
an optical system configured to guide light traveling via the mirror surface of the deformable mirror device to an light receiving device.
